(19) United States
(12) Patent Application Publication
(10) Pub. No.: US 2016/0110043 A1
(43) Pub. Date: Apr. 21, 2016

(54) A METHOD FOR CREATING A BOOK

(71) Applicant: Serge HILLEBRAND, Attendorn (DE)

(72) Inventor: SERGE HILLEBRAND, ATTENDORN (DE)

(21) Appl. No.: 14/889,971

(22) PCT Filed: May 5, 2014
(86) PCT No.: PCT/IB2014/000653

§ 371 Date: Nov. 9, 2015

(30) Foreign Application Priority Data
May 7, 2013 (GB) 1308500.6

(51) Int. Cl. G06F 3/0483; G06F 17/30; G06F 7/24

(52) U.S. Cl. CPC G06F 3/0483; G06F 7/24; G06F 17/30389

(57) ABSTRACT

The present disclosure is directed to a method for creating a book about a specific object, comprising a user interface and a memory accessible by the interface. The interface being accessible by at least one data provider and by a data collector instructing the interface. The method comprises: the interface requesting from, the data collector basic information about the specific object and storing that in the memory; providing a space in the memory for the data to be stored; the interface requesting from the data collector identification information about at least one data provider; the interface inviting the at least one data provider to add data relating to the specific object to the memory; the interface requesting the at least one data provider to sort the data to the memory; the interface notifying the data collector of the data added to the memory; and the interface inviting the data collector to retrieve the data of the memory, the data being sorted according to the basic information as a book and presented as a book to the data collector. The present disclosure is also directed to a book created by the method.

### TECHNICAL FIELD

The present disclosure relates to a method for creating a book. More particularly, the present disclosure relates to a system and a method for creating a database for making a book about a specific object, such as for example a person.

### BACKGROUND

Retrieving data and creating something out of that data are well established problems. Often it is difficult or even technically impossible to find the data or to even know if such data exists and where such data is. Often such data is information and such information may only be in the memory of a person's mind. It is a problem how such information can be identified and added to a database with the use of technical means.

To create a book is time consuming and can not be done by a computer alone. A human being is traditionally tasked with the work of writing a book by hand, word by word. Often the book is about some specific topic and facts needs to be researched and found and put together. This is time consuming, often difficult, for example knowing when in time something happened, or if an event was before or after another event. It is further a problem to find relevant facts and data. It is desirable if these issues could be made less complex.

It would be desirable to be able to create a set of data about a specific person or object. It would be desirable to be able to create a book about a specific person or object.

The present invention is directed to overcoming one or more of the problems as set forth above.

### SUMMARY

It is an object to provide a method for creating a book about a specific object. This object can be achieved by the features defined by the independent claim. Further enhancements are characterized by the dependent claims.

According to one embodiment, the present disclosure is directed to a method for creating a book about a specific object, comprising a user interface and a memory accessible by the interface. The interface being accessible by at least one data provider and by a data collector instructing the interface. The method comprises:

the interface requesting from the data collector basic information about the specific object and storing that in the memory;

providing a space in the memory for the data to be stored;

the interface requesting from the data collector identification information about at least one data provider;

the interface inviting the at least one data provider to add data relating to the specific object to the memory;

the interface requesting the at least one data provider to sort the data to the memory;

the interface notifying the data collector of the data added to the memory; and

the interface inviting the data collector to retrieve the data of the memory, the data being sorted according to the basic information as a book and presented as a book to the data collector.

According to one embodiment, the present disclosure is directed to a book created by the method.

At least one of the above embodiments provides one or more solutions to the problems and disadvantages with the background art. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment(s).

### BRIEF DESCRIPTION OF THE DRAWINGS

The accompanying drawing illustrates presently preferred exemplary embodiments of the disclosure, and together with the general description given above and the detailed description of the preferred embodiments given below, serves to explain, by way of example, the principles of the disclosure.

FIG. 1 is a diagrammatic illustration of exemplary embodiments of a method according to an embodiment of the present disclosure.

### DETAILED DESCRIPTION

While the disclosure relates to adding data to, how to build, a database, it overcomes the technical problems of how to find specific data and how to add that data to, and build, a database, especially how to make a book out of such data and present the collected data, database, as a book. A book can be for example an electronic book, a paper book, a book with ISBN identification, a private book, a book displayed on a web page, or a diary. Typically these books have one or more characteristics such as chapters, title of chapters, pictures, index, page numbers, ISBN number, etc., giving it the technical characteristics of a book rather than a database or collection of data.

More specifically the disclosure relates to the technical problem of how to add data about a specific person (or object) to a book (or a database), and how to technically realise, automate, that procedure, including finding and collecting the data and the facts. The disclosure relates to the technical problem of how to find data and information about a specific person and how to retrieve that. The disclosure relates to the technical problem of how to retrieve information about a specific person from a person (normally from the persons mind). The disclosure relates to the technical problem of how to make such data and information useful. The disclosure relates to the technical problem of how to make such data accessible. The disclosure relates to the technical problem of how to make a book.

Each step and/or feature of the independent claim is necessary for solving at least one of the technical problems mentioned above. One or a group of features can not be isolated or considered by itself or themselves, because they all are part of, and contribute to, the technical solution of the technical problems described above. Each feature of the independent claims has the synergetic effect of solving one or more of the technical problems mentioned above. Each feature of claim 1 has the synergetic effect of providing a method for creating a book about an object. It is how the features interact with each other that result in the solution of a method for creating a book about a specific object, e.g. a person.

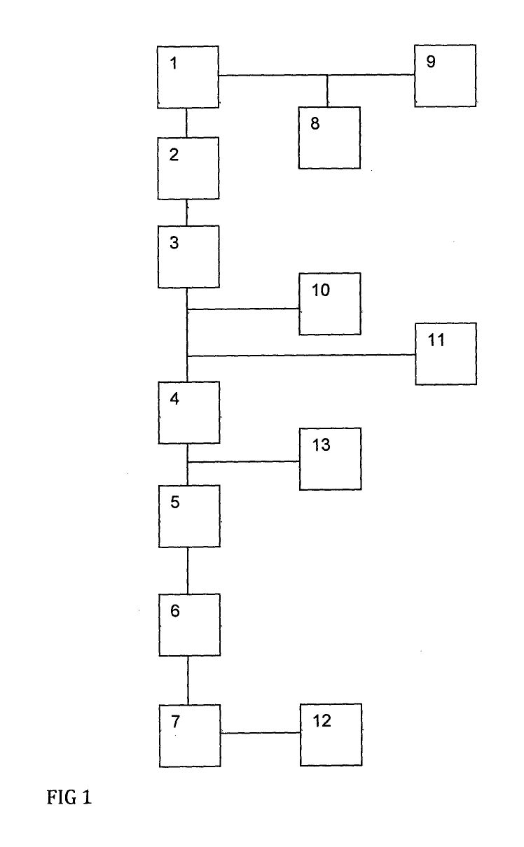

FIG. 1 is a diagrammatic illustration of exemplary embodiments of a method according to an embodiment of the present disclosure. FIG. 1 is only an example of an embodiment of the method and all boxes are not necessarily part of the method. The boxes illustrated in FIG. 1 need not to be made in order of their numbers. Their order is that what is described in this disclosure. The method may include one or more of the boxes in FIG. 1 and the illustration is for better understanding this disclosure and does not limit the scope of the claims.

At least one of the above mentioned technical problems is solved by the features defined in claim 1. Further enhancements and solutions are characterized by the dependent claims.

According to one embodiment, a method for creating a book about a specific object, may comprise a user interface and a memory accessible by the interface. The interface may be accessible by at least one data provider and by a data collector instructing the interface. The data collector may for example be a person who decides that he would like to have a biography written about himself. The at least one data provider may for example be one or more of his friends that can contribute to write about him. Such a data provider may for example be an old school friend who remembers details about the data collector when he was in school. This old school friend may therefore contribute to the biography with an event about the data collector that even the data collector does not remember.

The method of this embodiment may comprise a first step illustrated by box 1 in FIG. 1. This step may comprise the interface requesting from the data collector basic information about the specific object and storing that in the memory. For example, the data collector, the one who intends to create the book with help of the system and method, specifies the object by answering questions posed by the interface. For example, the object can be himself and he may give his name, date of birth, place of birth, etc. with the aim of creating a biography.

The method of this embodiment may comprise a second step illustrated by box 2 in FIG. 1. This step may comprise providing a space in the memory for the data to be stored. Given the specific object, memory space is reserved and/or identified for the storage of the information relating to the specific object.

The method of this embodiment may comprise a third step illustrated by box 3 in FIG. 1. This step may comprise the interface requesting from the data collector identification information about at least one data provider. For example, the interface may ask for name and contact information, such as an e-mail address to old school friends who can provide data. The interface may also look up part of such identification information by using address books, available information over the internet, asking additional questions, etc.

The method of this embodiment may comprise a fourth step illustrated by box 4 in FIG. 1. This step may comprise the interface inviting the at least one data provider to add data relating to the specific object to the memory. For example, the interface may contact and inform a data provider that the data collector has invited him to provide data to his book. Upon receiving such an invitation, the data provider then provides the system data, for example text and/or pictures concerning the specific object.

The method of this embodiment may comprise a fifth step illustrated by box 5 in FIG. 1. This step may comprise the interface requesting the at least one data provider to sort the data to the memory. Here the interface can for example ask the data provider to fit his data provided on a time line or according to a chapter. For example, for a biography the data provider could sort the data he provides according to the year, and/or according to a chapter such as for example military service or marriage.

The method of this embodiment may comprise a sixth step illustrated by box 6 in FIG. 1. This step may comprise the interface notifying the data collector of the data added to the memory. When data has been added by a data provider, the system may for example notify the data collector that data has been added. The data collector can then for example look at the data, as a ready chapter or part of a chapter. When enough data has been provided then the data collector may decide that now no more data can be provided. Additionally, the data collector may at this stage correct and edit data.

The method of this embodiment may comprise a seventh step illustrated by box 7 in FIG. 1. This step may comprise the interface inviting the data collector to retrieve the data of the memory, the data being sorted according to the basic information as a book and presented as a book to the data collector. At the final stage when enough data has been collected, the data collector may for example decide that he would like to have his biography printed as a book. The data is retrieved from the memory and presented in a book for with page numbers, chapters, front and back cover, etc. The data is also provided suitable to be printed as a book. The system may print the data as a book or send the book data to a publisher who can print it for the data collector. For example the system can arrange for an ISBN number. In this way the data collector obtains a book, for example a biography as given as an example above.

According to one embodiment, the book is one of the following group: an electronic book, a paper book, a book with ISBN identification, a private book, a book displayed on a web page, and a diary. Preferably the book is in paper form and is a book in the traditional sense with chapters, page numbers, perhaps pictures, front and back cover, etc. Thus, the book may have the technical features typically for a book, rather than that of a database.

The object may be a person, preferably the data collector. However, the object may be a thing, such as for example a boat or a car. For example, a data collector who has an old car can thus use the method for creating a book about his old car. Previous owners, car makers, mechanics can thus be invited as data providers by the method and contribute to create the book.

According to one embodiment, the interface is accessible over the Internet to the data collector and the at least one data provider. For example, the memory for the data may be connected to the internet to allow access by the data collector and provider to it. The use of the Internet may solve at least one of the technical problems mentioned above.

According to one embodiment, a third party, who has an interest in the book, has access to a separate part of the interface to provide data, the part of the interface being different from the interface of the data provider or the interface of the data collector. This is illustrated by box 8 in FIG. 1. For example, a company may have an interest in the object and may therefor like to promote data provision or provide data themselves. For example, certain data may only be available to the company, for example flight ticket information, which may be of interest for the book.

In one embodiment, such access is subject to the approval of the data collector and/or the data provider. This is illustrated by box 9 in FIG. 1. For example, a company can only access the system with the approval of the data collector. For example, the company may suggest or inform someone that a book can be created for a specific object. Such a book can thus first be created when the data collector approves and starts the system and method for creating a book. It is an example that boxes 8 and 9 have been added to box 1 in FIG. 1, and the boxes 8 and 9 can be added to any suitable box in FIG. 1.

In one embodiment the data collector and the at least one data provider are human beings. In one embodiment they can be a mixture of human beings and, for example, existing data bases where data can be provided to the system for creating a book.

According to one embodiment, the data collector can edit the book. In this way the data collector does not necessarily have to accept all the data that the data providers are providing. He may also rearrange the data, for example along a time line or to another chapter.

According to one embodiment, the at least one data provider can request the interface to invite at least one further data provider. This is illustrated by box 10 in FIG. 1. It does thus not necessarily have to be only the data collector that indicates the data provider. For example, the data provider may not remember the names of all his teachers that he would like to invite as data providers for his biography. However, one or more data providers, such as his old school friends may remember and may then invite that teacher to become a data provider. It is merely an example that box 10 has been added between box 3 and box 4 in FIG. 1, and box 10 may be added to any suitable location in FIG. 1.

According to one embodiment, the interface invites the data collector and the at least one data provider to use their contact information on other systems on the internet to search for further possible data providers. This is illustrated by box 11 in FIG. 1. For example, the. address book of the data collector may be used by the interface to suggest further data providers or to find identification data, such as addresses, for data providers. For example the address book of a data provider may lead to another further data provider. It is merely an example that box 11 has been added between box 3 and box 4 in FIG. 1, and box 11 may be added to any suitable location in FIG. 1.

According to one embodiment, the data collector can, set up a time. frame or event frame through the interface to allow the data provider to sort the added data according to such a time or event frame. For example, dates and/or months and/or years may be pre-set by the data collector for the data provider to sort his data. In addition, or as an alternative, events, such as for example, birth, preschool, university time, marriage, divorce, etc., can be pre-set events by the data collector for the data provider to sort his data according.

According to one embodiment, the basic information is one or more of the following group: name of a person, data identifying an object, data identifying a person, one or more dates, events, time line, and title of one or more chapters of the book.

According to one embodiment, a change in the memory is notified to the data collector. For example, if the change reflects that data has been provided to all pre-set events, then the data collector may be notified that the book may be ready.

According to one embodiment, the method comprises to arrange for an ISBN number for the final book. This is illustrated by box 12 in FIG. 1. It is merely an example that box 12 has been added to box 7 in FIG. 1, and box 12 may be added to any suitable location in FIG. 1. As a result, for example, the data collector can get an official book that he can supply to a publisher who in turn can sell the book for the data collector.

According to one embodiment, the method comprises to arrange that the data collector gets the full intellectual property right for the complete final book, by the interface requesting the at least one data provider to assign the intellectual property right to the data collector. This is illustrated by box 13 in FIG. 1. It is merely an example that box 13 has been added between box 4 and box 5 in FIG. 1, and box 13 may be added to any suitable location in FIG. 1. For example, when the data provider would like to provide data, for example write, about the specific object, then he may be asked by the interface to give the copyright in his written material to the data collector. In this way the data collector may in the end, when the book is ready, be sure that he is the rightful owner and copyright holder of the book.

According to one embodiment, a book created by the method as described herein may have a specific identification. For example, it may be evident from the ISBN number, or the book itself that it has been created by the described method and system.

It will be apparent to those skilled in the art that various modifications and variations can be made to the method, system, and book. Other embodiments will be apparent to those skilled in the art from consideration of the specification and practice of the disclosed apparatus and method. It is intended that the specification and examples be considered as exemplary only, with a true scope being, indicated by the following claims and their equivalents.

1. A method for creating a book about a specific object, comprising a user interface and a memory accessible by the interface, the interface being accessible by at least one data provider and by a data collector instructing the interface,
the method comprising:
the interface requesting from the data collector basic information about the specific object and storing that in the memory;
providing a space in the memory for the data to be stored;
the interface requesting from the data collector identification information about at least one data provider;
the interface inviting the at least one data provider to add data relating to the specific object to the memory;
the interface requesting the at least one data provider to sort the data to the memory;
the interface notifying the data collector of the data added to the memory; and
the interface inviting the data collector to retrieve the data of the memory, the data being sorted according to the basic information as a book and presented as a book to the data collector.

2. The method according to claim 1, wherein the book is one of the following group: an electronic book, a paper book, a book with ISBN identification, a private book, a book displayed on a web page, and a diary.

3. The method according to claim 1, wherein the object is a person; preferably the data collector.

4. The method according to claim 1, wherein the interface is accessible over the internet to the data collector and the at least one data provider.

5. The method according to claim 1, wherein a third party, who has an interest in the book, has access to a separate part of the interface to provide data, the part of the interface being different from the interface of the data provider or the interface of the data collector.

6. The method according to claim 5, wherein the access is subject to the approval of the data collector and the data provider.

7. The method according to claim 1, wherein the data collector and the at least one data provider are human beings.

8. The method according to claim 1, wherein the data collector can edit the book.

9. The method according to claim 1, wherein the at least one data provider can request the interface to invite at least one further data provider.

10. The method according to claim 1, wherein the interface invites the data collector and the at least one data provider to use their contact information on other systems on the internet to search for further possible data providers.

11. The method according to claim 1, wherein the data collector can set up a time frame or event frame through the interface to allow the data provider to sort the added data according to such a time or event frame.

12. The method according to claim 1, wherein the basic information is one or more of the following group: name of a person, data identifying an object, data identifying a person, one or more dates, events, time line, and title of one or more chapters of the book.

13. The method according to claim 1, wherein a change in the memory is notified to the data collector.

14. The method according to claim 1, wherein the method comprises to arrange for an ISBN number for the final book.

15. The method according to claim 1, wherein the method comprises to arrange that the data collector gets the full intellectual property right for the complete final book, by the interface requesting the at least one data provider to assign the intellectual property right to the data collector.

16. A book created by the method according to claim 1.

17. (canceled)
